(19) United States
(12) Patent Application Publication
(10) Pub. No.: US 2013/0182090 A1
(43) Pub. Date: Jul. 18, 2013

(54) IMAGE PICKUP DEVICE AND ENDOSCOPIC DEVICE

(71) Applicant: OLYMPUS CORPORATION, Tokyo (JP)

(72) Inventor: Yoshio Hagihara, Tokyo (JP)

(73) Assignee: OLYMPUS CORPORATION, Tokyo (JP)

(21) Appl. No.: 13/742,920

(22) Filed: Jan. 16, 2013

(30) Foreign Application Priority Data
Jan. 18, 2012 (JP) 2012-008094

(51) Int. Cl. H04N 5/335

(52) U.S. Cl. CPC H04N 5/335
USPC 348/65; 348/294

(57) ABSTRACT

An image pickup device includes, but is not limited to: an image pickup unit; a first selector; and an output unit. The image pickup unit includes a plurality of pixels arranged in a matrix. Each of the pixels is configured to generate, store, and output a pixel signal. The first selector is configured to select a column of the matrix and control the pixels arranged in the column selected. The output unit is configured to convert into a voltage signal, the pixel signal output from each of the pixels.

### BACKGROUND OF THE INVENTION

1. Field of the Invention

The present invention relates to an image pickup device and an endoscopic device including the image pickup device.

Priority is claimed on Japanese Patent Application No. 2012-008094, filed Jan. 18, 2012, the content of which is incorporated herein by reference.

2. Description of the Related Art

Regarding image pickup devices, various types of image pickup devices, such as MOS (metal oxide semiconductor) type image pickup devices and CCD (charge coupled device) type image pickup devices, have been proposed so far and actually used. As one of the MOS (metal oxide semiconductor) type image pickup devices, a (C)MOS type image pickup device includes APS (active pixel sensor) pixels. The APS pixel is configured to amplify and output pixel signals in accordance with signal charge generated by a charge generator.

Hereinafter, a configuration of a (C)MOS type image pickup device according to a first related art (see, for example, Japanese Patent Laid-Open Publication No. 2000-4399). FIG. 8 illustrates a schematic configuration of the (C)MOS type image pickup device according to the related art. An image pickup device 1001 shown in FIG. 8 includes: an image pickup unit 1002; a vertical selector 1004; a column circuit unit 1005; a horizontal selector 1006; an output unit 1007; and a switch unit 1005.

The image pickup unit 1002 includes multiple pixels 1003 arranged in a matrix. Each pixel 1003 includes: a charge generator PD (such as a photodiode); a transfer transistor Tx; a charge storing unit FD (such as a floating diffusion); a reset transistor Rst; an amplifier transistor Dry; and a select transistor Sel. In the case of FIG. 8, the image pickup unit 1002 includes pixels 1003 (M11, M12, M21, and M22) arranged in two rows and two columns. The charge generator PD generates signal charge according to the amount of an incident electromagnetic wave. The transfer transistor Tx transfers the signal charge generated by the charge generator PD to the charge storing unit FD. The charge storing unit FD stores the transferred signal charge. The reset transistor Rst resets the charge storing unit FD to a predetermined reset voltage (a power voltage VDD in this case). The amplifier transistor Dry amplifies the signal in accordance with the voltage of the charge storing unit FD, and generates a pixel signal. The select transistor Sel outputs the pixel signal to a vertical signal line 1030 provided for each column of the image pickup unit 1002. A reset level and a signal level are output from the pixel 1003, as pixel signals. The transfer transistor Tx is controlled by a transfer pulse output from the vertical selector 1004. In FIG. 8, φTx_1 denotes a transfer pulse output to the pixels 1003 (M11, M12) arranged in the first row, and φTx_2 denotes a transfer pulse output to the pixels 1003 (M21, M22) arranged in the second row. The reset transistor Rst is controlled by a reset pulse output from the vertical selector 1004. In FIG. 8, φRst_1 denotes a reset pulse output to the pixels 1003 (M11, M12) arranged in the first row, and φRst_2 denotes a reset pulse output to the pixels 1003 (M21, M22) arranged in the second row. In FIG. 8, φSel_1 denotes a select pulse output to the pixels 1003 (M11, M12) arranged in the first row, and φSel_2 denotes a select pulse output to the pixels 1003 (M21, M22) arranged in the second row.

The vertical selector 1004 selects pixels 1003 arranged in a row of the image pickup unit 1002 and controls operations of the selected pixels 1003. The switch unit 1005 includes a select switch SW provided for each column. The select switch SW is coupled to a vertical signal line 1030 and a horizontal signal line 1031. The select switch SW outputs to the horizontal signal line 1031, the pixel signals output to the vertical signal line 1030. The select switch SW in the first column is controlled by a select pulse HSR[0] output from the horizontal selector 1006. The select switch SW in the second column is controlled by a select pulse HSR[1] output from the horizontal selector 1006. The horizontal signal line 1031 is coupled to the output unit 1007.

The horizontal selector 1006 sequentially selects the select switches SW based on the select pulses HSR[0] and HSR[1], and transfers the pixel signals to the output unit 1007. These pixels signals are input to the output unit 1007, as current signals. The output unit 1007 is biased by the bias voltage LMBN. The output unit 1007 converts pixel signals into voltage signals and outputs the voltage signals to a downstream circuit.

Regarding the image pickup device 1001 shown in FIG. 8, the horizontal selector 1006 is placed close to the image pickup unit 1002 (on the bottom side of the image pickup device 1001 in the case of FIG. 8), in order to sequentially select the select switches SW in the switch unit 1005. Additionally, the horizontal selector 1006 and the output unit 1007 are placed close to each other, in order to prevent noise from being included in analog pixel signals output to the horizontal signal lines 1031. The signals sequentially output from the output unit 1007 are output via amplifier circuits, output pads, or the like.

Regarding endoscopic devices, on the other hand, it is preferable to reduce the size of a chip and minimize the size of a peripheral circuit in order to thin the scope, and to maximize the size of an image pickup unit in order to improve the sensitivity.

Further, it is preferable to match the center of the chip with the center of the image pickup unit while matching the center of the image pickup unit with an optical axis of an optical system included in the image pickup unit, in order to simplify a mounting.

### SUMMARY

According to one embodiment, an image pickup device includes, but is not limited to: an image pickup unit; a first selector; and an output unit. The image pickup unit includes a plurality of pixels arranged in a matrix. Each of the pixels is configured to generate, store, and output a pixel signal. The first selector is configured to select a column of the matrix and control the pixels arranged in the column selected. The output unit is configured to convert into a voltage signal, the pixel signal output from each of the pixels. The image pickup unit is positioned between the first selector and the output unit.

According to another embodiment, an image pickup device includes, but is not limited to: a first pixel; a first switch; and an output unit. The first pixel is configured to generate, store, and output a first pixel signal. The first switch configured to switch whether or not to supply a power voltage to the first pixel. The output unit is configured to convert into a first voltage signal, the first pixel signal output from the first pixel, and output the first voltage signal. The first pixel is positioned between the first switch and the output unit.

According to another embodiment, an endoscopic device includes, but is not limited to: an image pickup device; and an image processor configured to perform a predetermined process on a signal output from the image pickup device to generate an image. The image pickup device includes, but is not limited to: a first pixel; a first switch; and an output unit. The first pixel is configured to generate, store, and output a first pixel signal. The first switch configured to switch whether or not to supply a power voltage to the first pixel. The output unit is configured to convert into a first voltage signal, the first pixel signal output from the first pixel, and output the first voltage signal. The first pixel is positioned between the first switch and the output unit.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a configuration diagram illustrating a configuration of an image pickup device according to a first embodiment of the present invention;

FIG. 2 is a timing chart illustrating operation of the image pickup device according to the first embodiment;

FIG. 3 is a circuit diagram illustrating a configuration of pixels included in an image pickup device according to a second embodiment of the present invention;

FIG. 4 is a timing chart illustrating operation of the image pickup device according to the second embodiment;

FIG. 5 is a configuration diagram illustrating a configuration of an image pickup device according to a third embodiment of the present invention;

FIG. 6 is a configuration diagram illustrating a configuration of an image pickup device according to a fourth embodiment of the present invention;

FIG. 7 is a configuration diagram illustrating a configuration of an endoscopic device according to a fifth embodiment of the present invention; and

FIG. 8 is a configuration diagram illustrating a configuration of an image pickup device according to a related art.

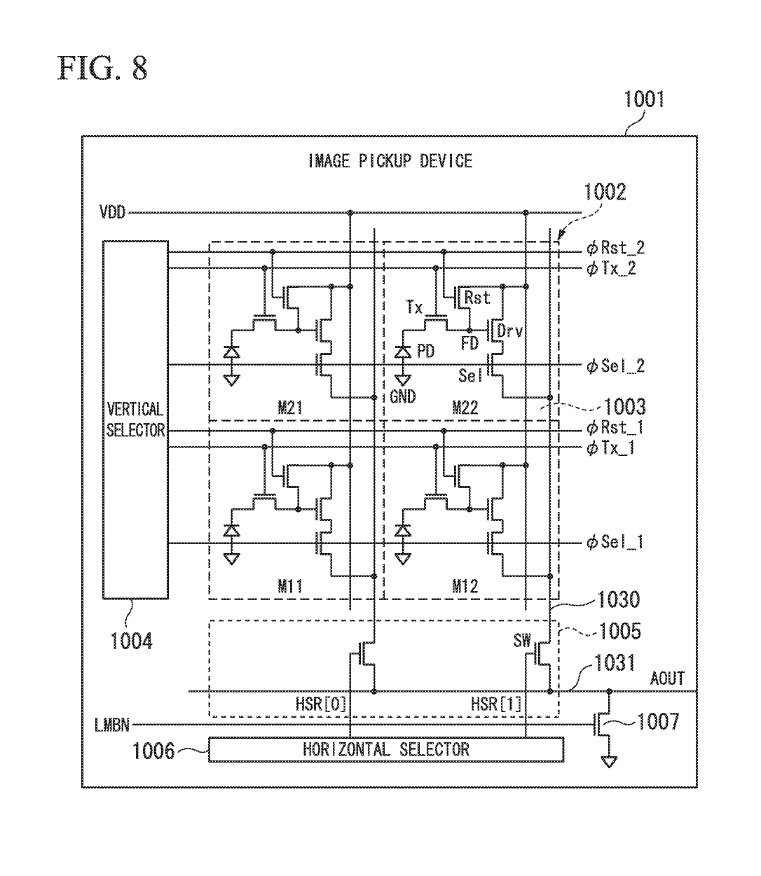

### DETAILED DESCRIPTION OF THE PREFERRED EMBODIMENTS

The present invention will now be described herein with reference to illustrative embodiments. The accompanying drawings explain image pickup devices and an endoscopic device in the embodiments. The size, the thickness, and the like of each illustrated portion might be different from those of each portion of actual image pickup devices and an actual endoscopic device.

Those skilled in the art will recognize that many alternative embodiments can be accomplished using the teachings of the present invention and that the present invention is not limited to the embodiments illustrated herein for explanatory purposes.

### First Embodiment

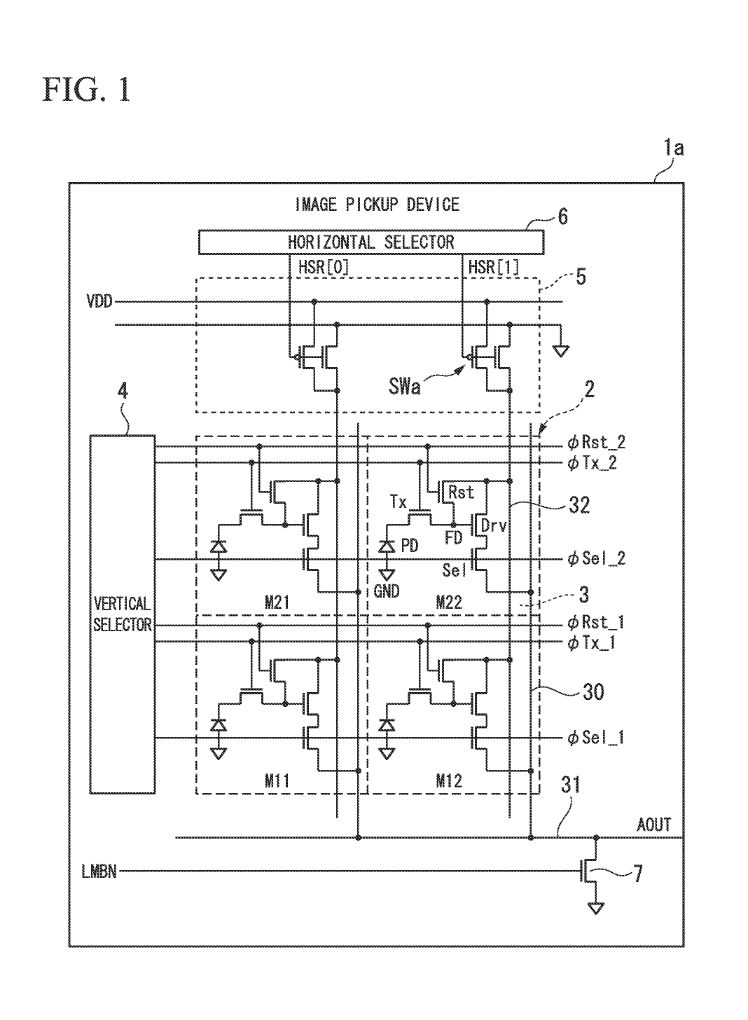

Hereinafter, a first embodiment of the present invention is explained. FIG. 1 is a configuration diagram illustrating a configuration of an image pickup device 1a according to the first embodiment. A configuration of the image pickup device 1a according to the first embodiment is explained here. The image pickup device 1a shown in FIG. 1 includes: an image pickup unit 2; a vertical selector 4; a switch unit 5; a horizontal selector 6; and an output unit 7.

The image pickup unit 2 includes multiple pixels 3 arranged in a matrix. Each pixel 3 includes: a charge generator PD (such as a photodiode); a transfer transistor Tx; a charge storing unit FD (such as a floating diffusion); a reset transistor Rst; an amplifier transistor Dry (signal generator); and a select transistor Sel. In the case of FIG. 1, the image pickup unit 2 includes pixels 3 (M11, M12, M21, and M22) arranged in two rows and two columns.

The charge generator PD generates signal charge according to the amount of an incident electromagnetic wave. The transfer transistor Tx transfers the signal charge generated by the charge generator PD to the charge storing unit FD. The charge generator PD and the transfer transistor Tx constitute a unit cell unit. The charge storing unit FD stores the transferred signal charge. The reset transistor Rst resets the charge storing unit FD to a predetermined reset voltage (a power voltage VDD in this case). The amplifier transistor Dry amplifies the signal in accordance with the voltage of the charge storing unit FD, and generates a pixel signal. The select transistor Sel outputs the pixel signal to a vertical signal line 30 provided for each column of the image pickup unit 2. A reset level and a signal level are output from the pixel 3, as pixel signals.

One terminal of the charge generator PD is coupled to a ground GND, and the outer terminal thereof is coupled to the transfer transistor Tx. The transfer transistor Tx includes, for example, an NMOS transistor including: a drain terminal coupled to the other terminal of the charge generator PD; a source terminal coupled to the charge storing unit FD; and a gate terminal coupled to a control signal line extending from the vertical selector 4 in the row direction. The reset transistor Rst includes, for example, an NMOS transistor including: a drain terminal coupled to a power line 32 which is provided for each column and configured to supply the power voltage VDD to the pixels 3; a source terminal coupled to the charge storing unit FD; and a gate terminal coupled to the control signal line extending from the vertical selector 4 in the row direction.

The amplifier transistor Dry includes, for example, an NMOS transistor including: a drain terminal coupled to the power line 32; a source terminal coupled to the select transistor Sel; and a gate terminal coupled to the charge storing unit FD. The select transistor Sel includes, for example, an NMOS transistor including: a drain terminal coupled to the amplifier transistor Dry; a source terminal coupled to the vertical signal line 30; and a gate terminal coupled to the control signal line extending from the vertical selector 4 in the row direction.

The transfer transistor Tx is controlled by a transfer pulse output from the vertical selector 4. In FIG. 1, φTx_1 denotes a transfer pulse output to the pixels 3 (M11, M12) arranged in the first row, and φTx_2 denotes a transfer pulse output to the pixels 3 (M21, M22) arranged in the second row. The reset transistor Rst is controlled by a reset pulse output from the vertical selector 1004. In FIG. 1, φRst_1 denotes a reset pulse output to the pixels 3 (M11, M12) arranged in the first row, and φRst_2 denotes a reset pulse output to the pixels 3 (M21, M22) arranged in the second row. The select transistor Sel is controlled by a select pulse output from the vertical selector 4. In FIG. 1, φSel_1 denotes a select pulse output to the pixels 3 (M11, M12) arranged in the first row, and φSel_2 denotes a select pulse output to the pixels 3 (M21, M22) arranged in the second row.

The vertical selector 4 selects pixels 3 arranged in the row direction of the image pickup unit 2 and controls operations of the selected pixels 3. The switch unit 5 includes a select switch SWa provided for each column. The select switch SWa includes a PMOS transistor and an NMOS transistor. The PMOS transistor included in the select switch SWa includes: a drain terminal coupled to the power line 32; a source terminal coupled to the power voltage VDD; and a gate terminal coupled to the horizontal selector 6. The NMOS transistor included in the select switch SWa includes:

a drain terminal coupled to the power line 32; a source terminal coupled to the ground; and a gate terminal coupled to the horizontal selector 6. Each transistor included in the select switch SWa in the first column is controlled by a select pulse HSR[0] output from the horizontal selector 6. Each transistor included in the select switch SWa in the second column is controlled by a select pulse HSR[1] output from the horizontal selector 6.

The horizontal selector 6 sequentially selects the select switches SWa based on the select pulses HSR[0] and HSR[1] to control the voltage of the power line 32 (power voltage VDD or ground), and transfers the pixel signals to the output unit 7. These pixel signals are input to the output unit 7, as current signals. The output unit 7 converts pixel signals into voltage signals and outputs the voltage signals to a downstream circuit. The output unit 7 includes, for example, an NMOS transistor including: a drain terminal coupled to the horizontal signal line 31; a source terminal coupled to the ground; and a gate terminal coupled to the bias voltage LMBN. The output unit 7 is biased by the bias voltage LMBN.

In the first embodiment, the image pickup unit 2 has a rectangular shape (substantially a square shape) as indicated by a dashed line shown in FIG. 1, if viewed in a direction parallel to an optical axis of an optical system that forms a subject image on the image pickup unit 2. The shape of the image pickup unit 2 is visible as a shape of the arrangement of the pixels 3 or a shape of an opening provided in a light shielding layer (not shown) formed over the image pickup unit 2.

The horizontal selector 6 and the output unit 7 are respectively placed along sides of the image pickup unit 2, which are not adjacent to each other. Specifically, the horizontal selector 6 is placed along an upper side of the image pickup unit 2. The output unit 7 is placed along a lower side of the image pickup unit 2. “Is placed along a side” means being placed in the vicinity of a line segment constituting the side, or being placed in the vicinity of a straight line obtained by extending that line segment. The horizontal selector 6 and the output unit 7 are respectively placed along two opposing sides of the image pickup unit 2, and distanced from each other by more than n times the pixel pitch (where n is the number of rows or columns, which is 2 in this case). Thus, the horizontal selector 6 that is relatively a large circuit, and the output unit 7 in the vicinity of which an amplifier circuit with large area, output pads, or the like are placed, are placed separately while sandwiching the image pickup unit 2 therebetween. Accordingly, it is possible to easily match the center of the chip with the center of the image pickup unit without significantly increasing the chip area.

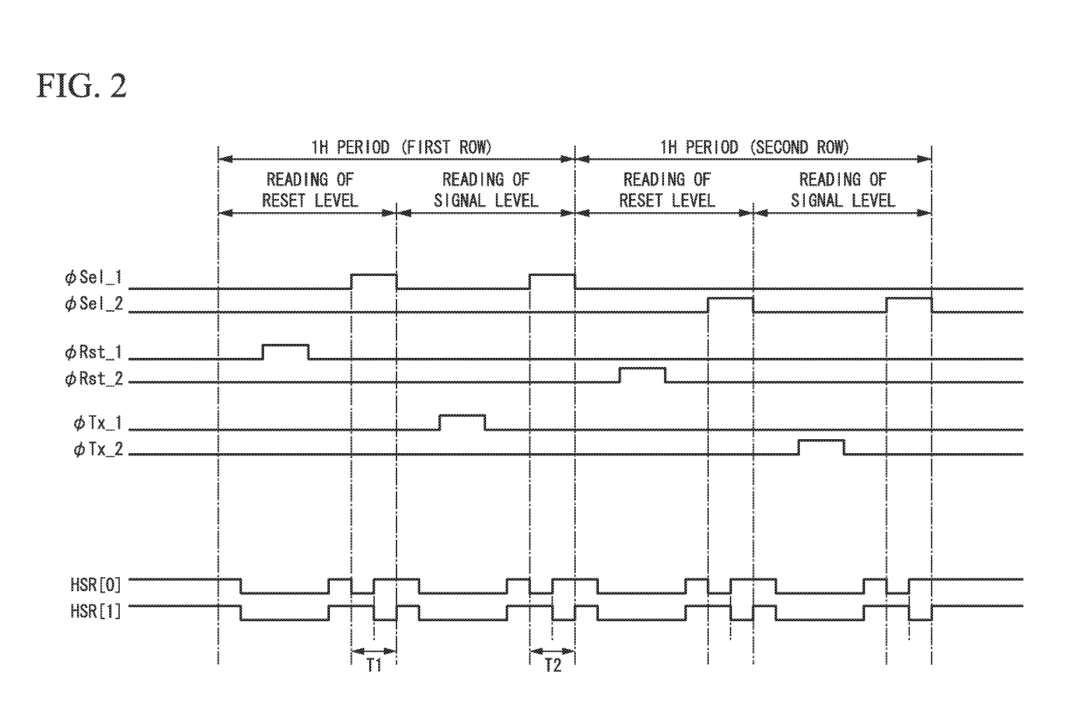

Hereinafter, operation of the image pickup device according to the first embodiment is explained. FIG. 2 illustrates operation of the image pickup device according to the first embodiment. At the start of the operation, the select pulses HSR[0] and HSR[1] output to the select switches SWa in the respective lines are in H (high) state. For this reason, the PMOS transistor included in the select switch SWa in each column is OFF (non-conductive state), and the NMOS transistor included in the select switch SWa in each column is ON (conductive state). Therefore, the power line 32 in each column is coupled to the ground.

### (Reading of Pixel Signal in First Row)

### (Reading of Reset Level)

Firstly, the select pulses HSR[0] and HSR[1] output to the select switches SWa in the respective columns change from H state to L (low) state. Thereby, the PMOS transistor included in the select switch SWa in each column becomes ON, and the NMOS transistor included in the select switch SWa in each column becomes OFF. For this reason, the power line 32 in each column is coupled to the power voltage VDD. Then, the reset pulse φRst_1 output to the pixels 3 arranged in the first row changes from L state to H state. Thereby, the reset transistor Rst becomes ON, and the charge storing unit FD is reset. Then, the reset pulse φRst_1 output to the pixels 3 arranged in the first row changes from H state to L state. Thereby, the reset transistor Rst becomes OFF.

Then, the select pulses HSR[0] and HSR[1] output to the select switches SWa in the respective columns change from L state to H state. Thereby, the PMOS transistor included in the select switch SWa in each column becomes OFF, and the NMOS transistor included in the select switch SWa in each column becomes ON. For this reason, the power line 32 in each column is coupled to the ground.

Then, the reset pulse φSel_1 output to the pixels 3 arranged in the first row changes from L state to H state. Thereby, the select transistor becomes ON, and thus the pixels 3 arranged in the first row are selected. At substantially the same time, the select pulse HSR[0] output to the select switch SWa in the first column changes from H state to L state. Thereby, the PMOS transistor included in the select switch SWa in the first column becomes ON, and the NMOS transistor included in the select switch SWa in the first column becomes OFF. For this reason, the power line 32 in the first column is coupled to the power voltage VDD.

Thus, a pixel signal at the reset level is output from the pixel 3 (M11) in the first row and the first column to the vertical signal line 30. The pixel signal at the reset level, which is output to the vertical signal line 30, is output to the horizontal signal line 31, and then is input to the output unit 7. The output unit 7 converts into a voltage signal, the pixel signal at the reset level which is input as a current signal. Then, the output unit 7 outputs the voltage signal to the downstream circuit.

Subsequently, the select pulse HSR[0] output to the select switch SWa in the first column changes from L state to H state. Thereby, the PMOS transistor included in the select switch SWa in the first column becomes OFF, and the NMOS transistor included in the select switch SWa in the first column becomes ON. For this reason, the power line 32 in the first column is coupled to the ground. At substantially the same time, the select pulse HSR[1] output to the select switch SWa in the second column changes from H state to L state. Thereby, the PMOS transistor included in the select switch SWa in the second column becomes ON, and the NMOS transistor included in the select switch SWa in the second column becomes OFF. For this reason, the power line 32 in the second column is coupled to the power voltage VDD. Thus, a pixel signal at the reset level is output from the pixel 3 (M12) in the first row and the second column to the vertical signal line 30. The pixel signal at the reset level, which is output to the vertical signal line 30, is output to the horizontal signal line 31, and then is input to the output unit 7. The output unit 7 converts into a voltage signal, the pixel signal at the reset level which is input as a current signal. Then, the output unit 7 outputs the voltage signal to the downstream circuit.

Then, the select pulse HSR[1] output to the select switch SWa in the second column changes from L state to H state. Thereby, the PMOS transistor included in the select switch SWa in the second column becomes OFF, and the NMOS transistor included in the select switch SWa in the second column becomes ON. For this reason, the power line 32 in the second column is coupled to the ground. At substantially the same time, the select pulse φSel_1 output to the pixels 3 arranged in the first row changes from H state to L state. Thereby, the select transistor Sel becomes OFF, and the selection of the pixels 3 arranged in the first row is released.

### (Reading of Signal Level)

Firstly, the select pulses HSR[0] and HSR[1] output to the select switches SWa in the respective columns change from H state to L state. Thereby, the PMOS transistor included in the select switch SWa in each column becomes ON, and the NMOS transistor included in the select switch SWa in each column becomes OFF. For this reason, the power line 32 in each column is coupled to the power voltage VDD. Then, the transfer pulse φTx_1 output to the pixels 3 arranged in the first row changes from L state to H state. Thereby, the transfer transistor Tx becomes On, and thus the signal charge generated by the charge generator PD is transferred to the charge storing unit FD. Then, the transfer pulse φTx_1 output to the pixels 3 arranged in the first row changes from H state to L state. Thereby, the transfer transistor Tx becomes OFF.

Then, the select pulses HSR[0] and HSR[1] output to the select switches SWa in the respective columns change from L state to H state. Thereby, the PMOS transistor included in the select switch SWa in each column becomes OFF, and the NMOS transistor included in the select switch SWa in each column becomes ON. For this reason, the power line 32 in each column is coupled to the ground.

Then, the select pulse φSel_1 output to the pixels 3 arranged in the first row changes from L state to H state. Thereby, the select transistor Sel becomes ON, and thus the pixels 3 arranged in the first row are selected. At substantially the same time, the select pulse HSR[0] output to the select switch SWa in the first column changes from H state to L state. Thereby, the PMOS transistor included in the select switch SWa in first column becomes ON, and the NMOS transistor included in the select switch SWa in the first column becomes OFF. For this reason, the power line 32 in the first column is coupled to the power voltage VDD.

Thus, a pixel signal at the signal level is output from the pixel 3 (M11) in the first row and the first column to the vertical signal line 30. The pixel signal at the signal level, which is output to the vertical signal line 30, is output to the horizontal signal line 31, and then is input to the output unit 7. The output unit 7 converts into a voltage signal, the pixel signal at the signal level which is input as a current signal. Then, the output unit 7 outputs the voltage signal to the downstream circuit.

Then, the select pulse HSR[0] output to the select switch SWa in the first column changes from L state to H state. Thereby, the PMOS transistor included in the select switch SWa in the first column becomes OFF, and the NMOS transistor included in the select switch SWa in the first column becomes ON. For this reason, the power line 32 in the first column is coupled to the ground. At substantially the same time, the select pulse HSR[1] output to the select switch SWa in the second column changes from H state to L state. Thereby, the PMOS transistor included in the select switch SWa in second column becomes ON, and the NMOS transistor included in the select switch SWa in the second column becomes OFF. For this reason, the power line 32 in the second column is coupled to the power voltage VDD.

Thus, a pixel signal at the signal level is output from the pixel 3 (M12) in the first row and the second column to the vertical signal line 30. The pixel signal at the signal level, which is output to the vertical signal line 30, is output to the horizontal signal line 31, and then is input to the output unit 7. The output unit 7 converts into a voltage signal, the pixel signal at the signal level which is input as a current signal. Then, the output unit 7 outputs the voltage signal to the downstream circuit.

Then, the select pulse HSR[1] output to the select switch SWa in the second column changes from L state to H state. Thereby, the PMOS transistor included in the select switch SWa in the second column becomes OFF, and the NMOS transistor included in the select switch SWa in the second column becomes ON. For this reason, the power line 32 in the second column is coupled to the ground. At substantially the same time, the select pulse φSel_1 output to the pixels 3 arranged in the first row changes from H state to L state. Thereby, the select transistor Sel becomes OFF, and thus the selection of the pixels 3 arranged in the first row is released. Thus, the operation of reading the pixel signals from the pixels arranged in the first row ends.

### (Reading of Pixel Signals in Second Row)

Operation of reading pixel signals from the pixels 3 arranged in the second row is similar to the operation of reading pixel signals from the pixels 3 arranged in the first row, except that the pixels 3 arranged in the second row are selected based on the select pulse φSel_2 in lieu of the select pulse φSel_1, and therefore explanation thereof is omitted here. Finally, the downstream circuit performs a subtraction (CDS process) to obtain a signal element (signal obtained by calculating the difference between the reset level and the signal level). By the aforementioned operation, it is possible to easily read the pixel signals at the reset level and the pixel signals at the signal levels.

Although 2×2 pixels 3 (i.e., four pixels 3 in total) are arranged in the case of the image pickup device 1a shown in FIG. 1, the number of pixels 3 is not limited thereto. In a more general case where n×n pixels 3 are arranged (n is a natural number that is 3 or more), a pixel signal at the reset level and a pixel signal at the signal level are sequentially read for each row. Additionally, in a period in which the pixel signals at the reset level are output from the pixels 3 arranged in the first row (corresponding to the period T1 shown in FIG. 2), the pixel signals at the reset level are sequentially output from the pixels 3 arranged in each column. In a period in which the pixel signals at the signal level are output from the pixels 3 arranged in the first row (corresponding to the period T2 shown in FIG. 2), the pixel signals at the signal level are sequentially output from the pixels 3 arranged in each column.

As explained above, according to the first embodiment, the horizontal selector 6 and the output unit 7 are separately arranged respectively at the upper and lower positions, thereby making it possible to match the center of the chip with the center of the image pickup device. For this reason, it is possible to easily miniaturize image pickup devices.

### Second Embodiment

Hereinafter, a second embodiment of the present invention is explained. The difference between an image pickup device according to the second embodiment and the image pickup device la according to the first embodiment is a configuration of the image pickup unit 2. Specifically, the number of unit cell units of the pixels 3 constituting the image pickup unit 2 differs.

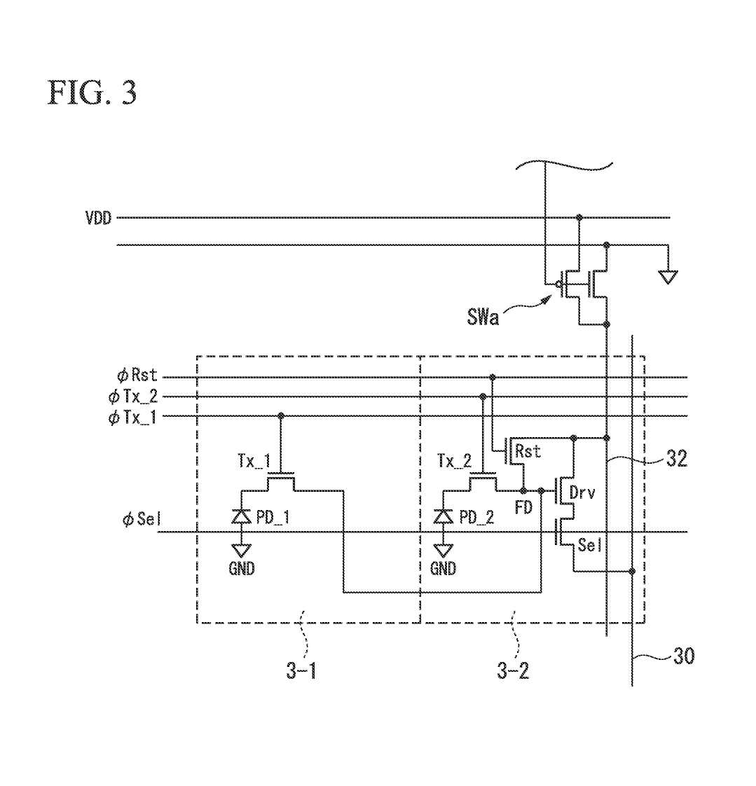

FIG. 3 illustrates a configuration of the pixels 3 of the second embodiment. FIG. 3 only shows the pixels 3 arranged in the first row, but a configuration of the pixels 3 arranged in the second row is similar thereto. The pixels 3 are 1×2 shared pixels. Specifically, the pixels 3 constitute two unit cell units adjacent in the row direction (unit cell units 3-1, 3-2). Other than that respect, the configuration of the pixels 3 of the second embodiment is substantially similar to that of the pixels 3 of the first embodiment, and therefore explanation is omitted here. Additionally, the vertical signal line 30 and the power line 32 are arranged only in the second column. Similarly, the select switch SWa of the switch unit 5 is placed only in the second column. The other configuration is substantially similar to that of the first embodiment, and therefore an explanation thereof is omitted here.

The unit cell unit 3-1 includes a charge generator PD_1 and a transfer transistor Tx_1. The unit cell unit 3-2 includes: a charge generator PD_2; a transfer transistor Tx_2; a charge storing unit FD; a reset transistor Rst; an amplifier transistor Dry; and a select transistor Sel. The charge storing unit FD, the reset transistor Rst, the amplifier transistor Dry, and the select transistor Sel are commonly used when pixel signals are read from the unit cell unit 3-1 and when pixel signals are read from the unit cell unit 3-2. Additionally, the transfer transistor Tx_1 is controlled by a transfer pulse φTx_1 output from the vertical selector 4, and the transfer transistor Tx_2 is controlled by a transfer pulse φTx_2 output from the vertical selector 4.

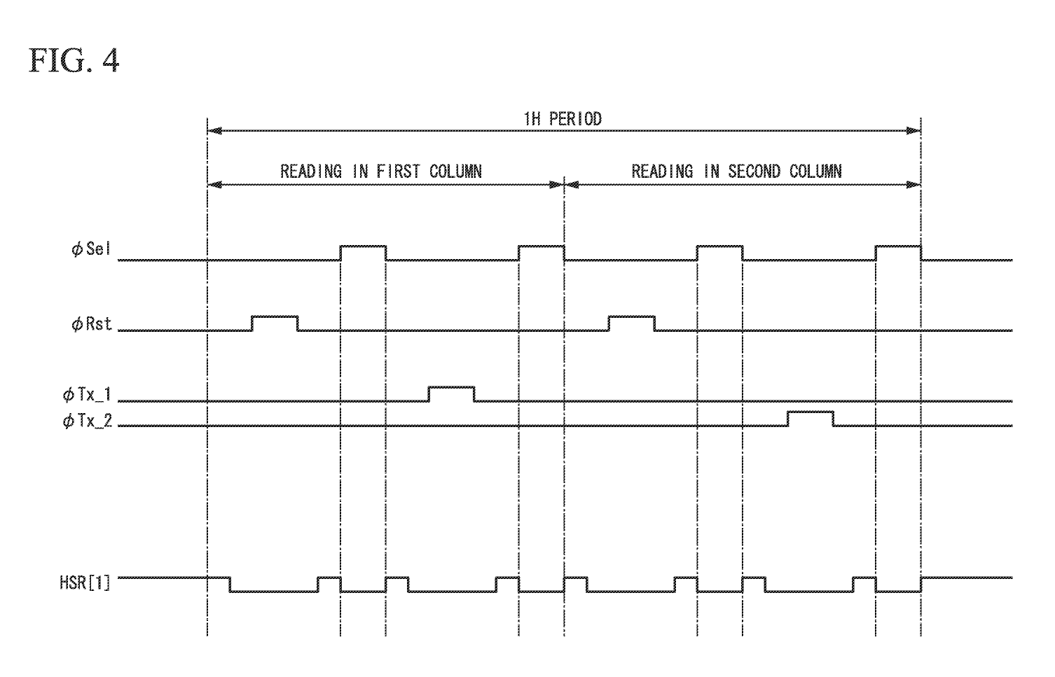

Hereinafter, operation of the image pickup device according to the second embodiment is explained. FIG. 4 illustrates the operation of the image pickup device according to the second embodiment. FIG. 4 only shows the operation with respect to the pixels 3 arranged in the first row. After a pixel signal at the reset level and a pixel signal at the signal level are read from one of the unit cell units 3-1 and 3-2, a pixel signal at the reset level and a pixel signal at the signal level are read from the other one of the unit cell units 3-1 and 3-2. Specific operation is as follows.

At the start of the operation, the select pulse HSR[1] output to the select switch SWa is in H state. For this reason, the PMOS transistor included in the select switch SWa is OFF, and the NMOS transistor included in the select switch SWa is ON. Therefore, the power line 32 is coupled to the ground.

(Reading of Pixel Signal from Unit Cell Unit 3-1)

### (Reading of Reset Level)

Firstly, the select pulse HSR[1] output to the select switch SWa changes from H state to L state. Thereby, the PMOS transistor included in the select switch SWa becomes ON, and the NMOS transistor included in the select switch SWa becomes OFF. For this reason, the power line 32 is coupled to the power voltage VDD. Then, the reset pulse φRst_1 output to the unit cell unit 3-2 in the first row changes from L state to H state. Thereby, the reset transistor Rst becomes ON, and the charge storing unit FD is reset. Then, the reset pulse φRst_1 output to the unit cell unit 3-2 in the first row changes from H state to L state. Thereby, the reset transistor Rst becomes OFF.

Then, the select pulse HSR[1] output to the select switch SWa changes from L state to H state. Thereby, the PMOS transistor included in the select switch SWa becomes OFF, and the NMOS transistor included in the select switch SWa becomes ON. For this reason, the power line 32 is coupled to the ground.

Then, the reset pulse φSel_1 output to the unit cell unit 3-2 in the first row changes from L state to H state. Thereby, the select transistor becomes ON, and thus the pixels 3 (unit cell units 3-1, 3-2) arranged in the first row are selected. At substantially the same time, the select pulse HSR[1] output to the select switch SWa changes from H state to L state. Thereby, the PMOS transistor included in the select switch SWa becomes ON, and the NMOS transistor included in the select switch SWa becomes OFF. For this reason, the power line 32 is coupled to the power voltage VDD.

Thus, a pixel signal at the reset level is output from the unit cell unit 3-2 in the first row to the vertical signal line 30. The pixel signal at the reset level, which is output to the vertical signal line 30, is output to the horizontal signal line 31, and then is input to the output unit 7. The output unit 7 converts into a voltage signal, the pixel signal at the reset level which is input as a current signal. Then, the output unit 7 outputs the voltage signal to the downstream circuit. The pixel signal is used as a pixel signal at the reset level in association with the unit cell unit 3-1 in the first row.

Then, the select pulse φSel output to the unit cell unit 3-2 in the first row changes from H state to L state. Thereby, the select transistor Sel becomes OFF, and the selection of the unit cell units 3-1 and 3-2 arranged in the first row is released. At substantially the same time, the select pulse HSR[1] output to the select switch SWa changes from L state to H state. Thereby, the PMOS transistor included in the select switch SWa becomes OFF, and the NMOS transistor included in the select switch SWa becomes ON. For this reason, the power line 32 is coupled to the ground.

### (Reading of Signal Level)

Firstly, the select pulse HSR[1] output to the select switch SWa changes from H state to L state. Thereby, the PMOS transistor included in the select switch SWa becomes ON, and the NMOS transistor included in the select switch SWa becomes OFF. For this reason, the power line 32 is coupled to the power voltage VDD. Then, the transfer pulse φTx_1 output to the unit cell unit 3-1 in the first row changes from L state to H state. Thereby, the transfer transistor Tx becomes On, and thus the signal charge generated by the charge generator PD_1 is transferred to the charge storing unit FD. Then, the transfer pulse φTx_1 output to the unit cell unit 3-1 in the first row changes from H state to L state. Thereby, the transfer transistor Tx_1 becomes OFF.

Then, the select pulse HSR[1] output to the select switch SWa changes from L state to H state. Thereby, the PMOS transistor included in the select switch SWa becomes OFF, and the NMOS transistor included in the select switch SWa becomes ON. For this reason, the power line 32 is coupled to the ground.

Then, the select pulse φSel output to the unit cell unit 3-2 in the first row changes from L state to H state. Thereby, the select transistor Sel becomes ON, and thus the pixels 3 (unit cell units 3-1, 3-2) arranged in the first row are selected. At substantially the same time, the select pulse HSR[1] output to the select switch SWa changes from H state to L state. Thereby, the PMOS transistor included in the select switch SWa becomes ON, and the NMOS transistor included in the select switch SWa becomes OFF. For this reason, the power line 32 is coupled to the power voltage VDD.

Thus, a pixel signal at the signal level is output from the unit cell unit 3-2 in the first row to the vertical signal line 30. The pixel signal at the signal level, which is output to the vertical signal line 30, is output to the horizontal signal line 31, and then is input to the output unit 7. The output unit 7 converts into a voltage signal, the pixel signal at the signal level which is input as a current signal. Then, the output unit 7 outputs the voltage signal to the downstream circuit. This pixel signal is used as a pixel signal at the signal level in association with the unit cell unit 3-1 in the first row.

Then, the select pulse φSel output to the unit cell unit 3-2 in the first row changes from H state to L state. Thereby, the select transistor Sel becomes OFF, and the selection of the unit cell units 3-1 and 3-2 arranged in the first row is released. At substantially the same time, the select pulse HSR[1] output to the select switch SWa changes from L state to H state. Thereby, the PMOS transistor included in the select switch SWa becomes OFF, and the NMOS transistor included in the select switch SWa becomes ON. For this reason, the power line 32 is coupled to the ground.

Thus, the operation of reading the pixel signal from the unit cell unit 3-1 ends. Subsequently, the downstream circuit performs a subtraction (CDS process) to obtain a signal element with respect to the unit cell unit 3-1 (signal obtained by calculating the difference between the reset level and the signal level).

(Reading of Pixel Signal from Unit Cell Unit 3-2)

Operation of reading a pixel signal from the unit cell unit 3-2 is similar to the operation of reading the pixel signal from the unit cell unit 3-1, except that signal charge is transferred from the charge generator PD_2 to the charge storing unit FD based on a transfer pulse φTx_2 in lieu of the transfer pulse φTx_1, and therefore explanation thereof is omitted here.

Although FIG. 3 shows the structure of the shared pixels in the case where 2×2 pixels 3 (i.e., four pixels 3 in total) are arranged, the number of pixels 3 is not limited thereto. In a more general case where n×n pixels 3 are arranged (n is a natural number that is 3 or more), 1×2 pixels 3 constitute shared pixels, and multiple sets of 1×2 shared pixels are arranged in the row direction of the image pickup unit 2, pixel signals are read as follows.

After a pixel signal at the reset level and a pixel signal at the signal level are read from one of the unit cell units 3-1 and 3-2 constituting each set of the shared pixels in a predetermined row, a pixel signal at the reset level and a pixel signal at the signal level is read from the other one of the unit cell units 3-1 and 3-2 constituting each set of shared pixels in the predetermined row. After similar operations are sequentially performed for all sets of shared pixels in the same row, the similar operations are performed for all sets of shared pixels in the next row.

As explained above, according to the second embodiment, the horizontal selector 6 and the output unit 7 are separately arranged respectively at the upper and lower positions, thereby making it possible to easily miniaturize image pickup devices. Additionally, it is possible to reduce the number of transistors constituting a pixel, thereby enabling further miniaturization of an image pickup device including an image pickup unit having the shared pixel structure.

### Third Embodiment

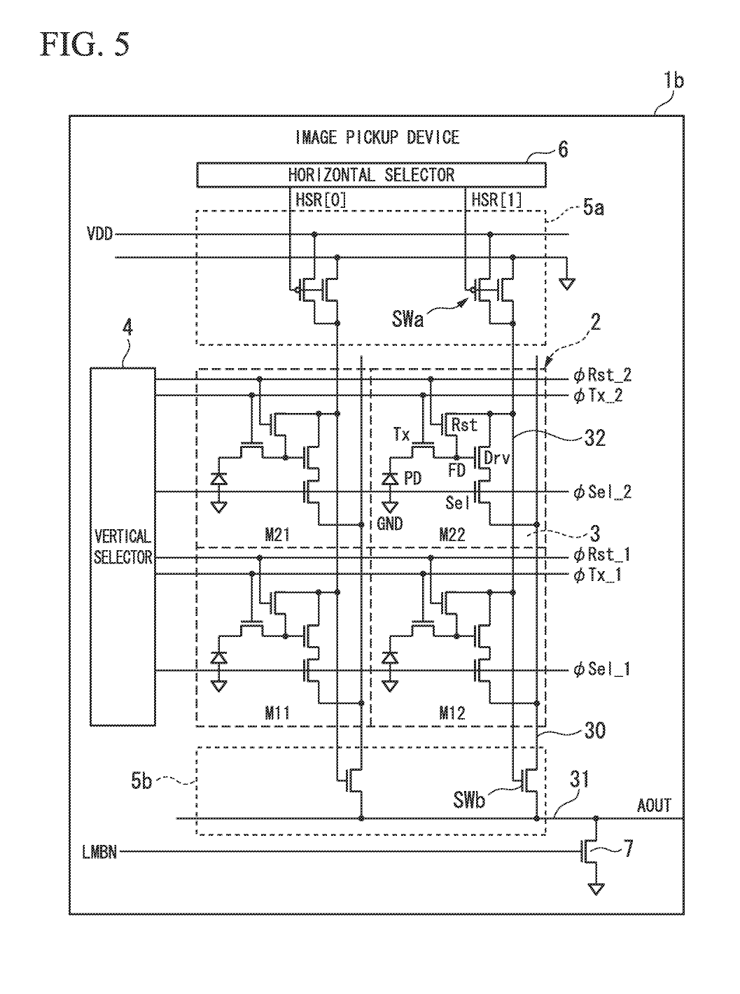

Hereinafter, a third embodiment of the present invention is explained. FIG. 5 illustrates a configuration of an image pickup device lb according to the third embodiment. A configuration of the third embodiment is explained here. The image pickup device lb shown in FIG. 5 differs from the image pickup device la of the first embodiment in that the switch unit 5 is replaced with a switch unit 5a and that a switch unit 5b is further provided.

The switch unit 5b includes a select switch SWb including an NMOS transistor. The NMOS transistor included in the select switch SWb includes: a drain terminal coupled to the vertical signal line 30; a source terminal coupled to the horizontal signal line 31; and a gate terminal coupled to the power line 32. The horizontal selector 6 sequentially selects the select switches SWa based on the select pulses HSR[0] and HSR[1], thereby controlling the voltage of the power line 32 (power voltage VDD or ground). Based on this control, the horizontal selector 6 further controls ON/OFF of the select switch SWb, thereby transferring pixel signals to the output unit 7.

When the select pulses HSR[0] and HSR[1] output to the select switches SWa are in H state, the PMOS transistor included in the select switch SWa becomes OFF, and the NMOS transistor included in the select switch SWa becomes ON. Thereby, the power line 32 is coupled to the ground. For this reason, the select switch SWb becomes OFF. When the select pulses HSR[0] and HSR[1] output to the select switches SWa are in L state, the PMOS transistor included in the select switch SWa becomes ON, and the NMOS transistor included in the select switch SWa becomes OFF. Thereby, the power line 32 is coupled to the power voltage VDD. For this reason, the select switch SWb becomes ON.

When a pixel signal is read from the pixel 3, the select switch SWb becomes ON, and the pixel signal output to the vertical signal line 30 is output to the horizontal signal line 31 via the select switch SWb, and then is input to the output unit 7. The other configuration is substantially similar to that of the first embodiment, and therefore explanation thereof is omitted here. Additionally, operation of the image pickup device according to the third embodiment is similar to the operation shown in FIG. 2, and therefore explanation thereof is omitted here.

As explained above, according to the third embodiment, the horizontal selector 6 and the output unit 7 are separately arranged respectively at the upper and lower positions, thereby making it possible to easily miniaturize image pickup devices.

Further, the following effect can be achieved by the third embodiment. In the first embodiment, the vertical signal line 30 and the horizontal signal line 31 are always coupled to each other, parasitic capacitance of the vertical signal lines 30 in all the columns serve as load. In the third embodiment, on the other hand, the vertical signal line 30 and the horizontal signal line 31 are separated by the select switch SWb. When a pixel signal output from the pixel 3 in one column is transferred to the output unit 7, the vertical signal lines 30 in the other columns are not coupled to the horizontal signal line 31, thereby reducing the load on the horizontal signal line 31. Accordingly, faster reading of pixel signals can be achieved by the minimum increase in the number of elements.

### Fourth Embodiment

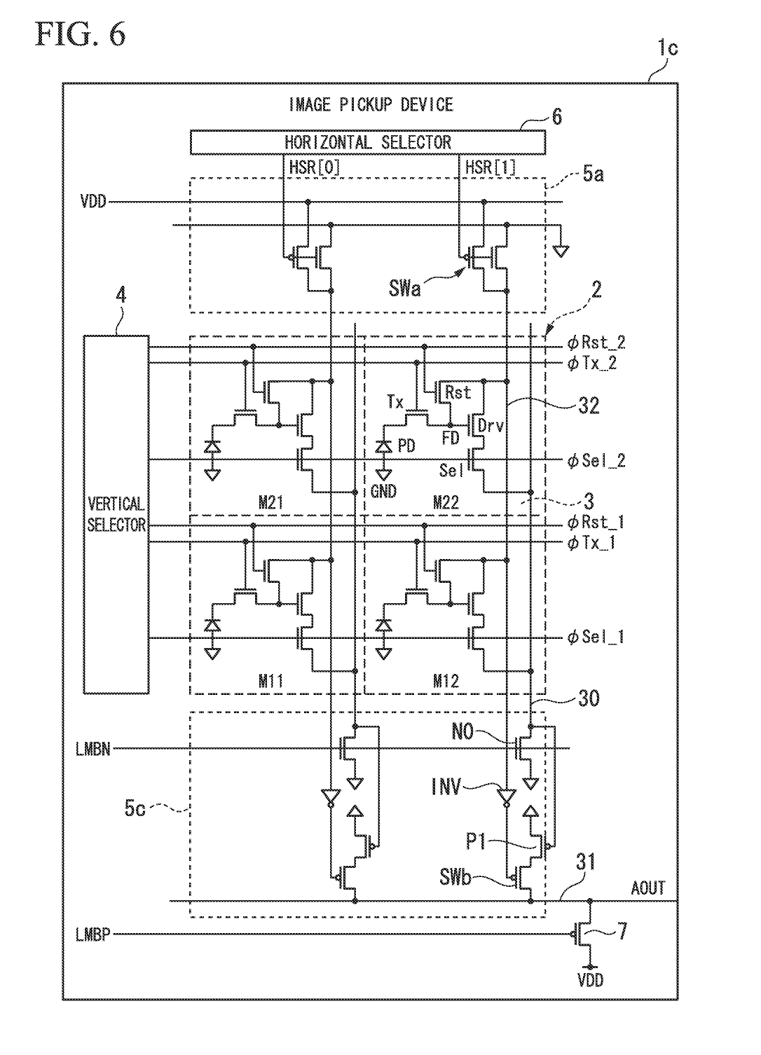

Hereinafter, a fourth embodiment of the present invention is explained. FIG. 6 illustrates a configuration of an image pickup device 1c according to the fourth embodiment. A configuration of the fourth embodiment is explained here. The difference between the image pickup device 1c shown in FIG. 6 and the image pickup device 1b of the third embodiment is a configuration of a switch unit 5c. The other configuration is substantially similar to that of the third embodiment. Therefore, only the configuration of the switch unit 5c is explained here.

The switch unit 5c includes: an NMOS transistor N0; a PMOS transistor P1; a select switch SWb; and a NOT circuit INV. The NMOS transistor N0 includes: a drain terminal coupled to the vertical signal line 30; a source terminal coupled to the ground; and a gate terminal coupled to the bias voltage LMBN. The PMOS transistor P1 includes: a source terminal coupled to the ground; a drain terminal coupled to a source terminal of the PMOS transistor included in the select switch SWb; and a gate terminal coupled to the drain terminal of the NMOS transistor N0.

The PMOS transistor included in the select switch SWb includes: a source terminal coupled to the drain terminal of the PMOS transistor P1; a drain terminal coupled to the horizontal signal line 31; and a gate terminal coupled to an output terminal of the NOT circuit INV. The input terminal of the NOT circuit INV is coupled to the power line 32. The horizontal selector 6 sequentially selects the select switches SWa based on the select pulses HSR[0] and HSR[1], thereby controlling the voltage of the power line 32 (power voltage VDD or ground). Based on this control, the horizontal selector 6 further controls ON/OFF of the select switch SWb, thereby transferring pixel signals to the output unit 7.

The output unit 7 of the fourth embodiment includes a PMOS transistor including: a source terminal coupled to the horizontal signal line 31; a drain terminal coupled to the power voltage VDD; and a gate terminal coupled to the bias voltage LMBP. Operation of the image pickup device 1c according to the fourth embodiment is similar to the operation shown in FIG. 2, and therefore explanation thereof is omitted here.

As explained above, according to the fourth embodiment, the horizontal selector 6 and the output unit 7 are separately arranged respectively at the upper and lower positions, thereby making it possible to easily miniaturize image pickup devices. Additionally, load on the signal line can be reduced, thereby achieving faster reading of pixel signals. Further, it is possible in the fourth embodiment to adjust the sizes of the PMOS transistor P1 and the select switch SWb independently of the pixel size in the vertical direction. For this reason, faster reading of pixel signals can be achieved by using a transistor with higher drive performance than that of the third embodiment.

### Fifth Embodiment

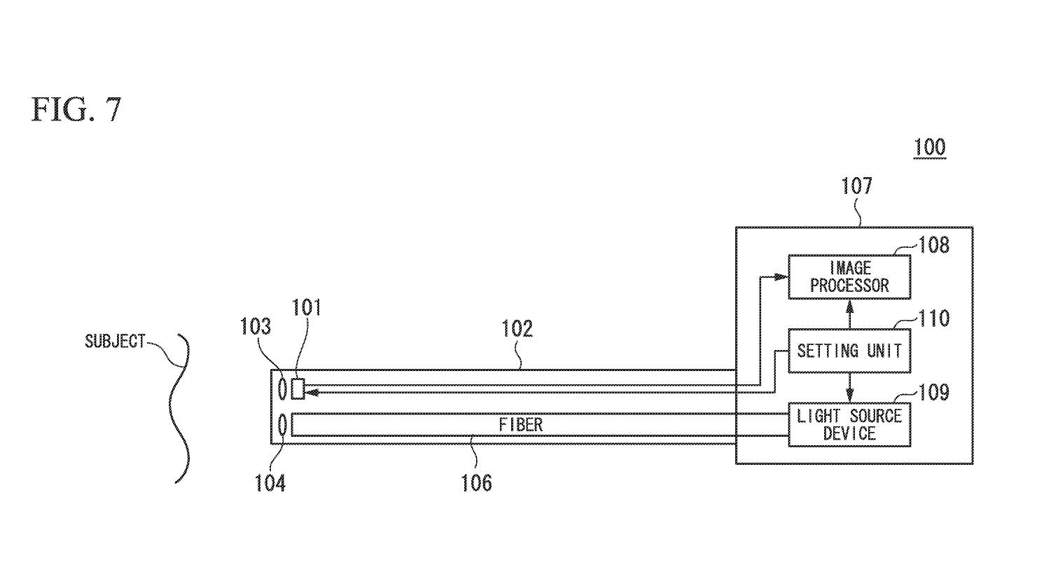

Hereinafter, a fifth embodiment of the present invention is explained. FIG. 7 illustrates a configuration of an endoscopic device 100 according to the fifth embodiment. A configuration of the endoscopic device 100 according to the fifth embodiment is explained.

The endoscopic device 100 shown in FIG. 7 includes a scope 102 and a chassis 107. The scope 102 includes: an image pickup device 101 that is an example of application of the present invention; a lens 103 that focuses light reflected from a subject to form an image on the image pickup image 101; a fiber 106 through which illuminated light passes to the subject; and a lens 104 that irradiates the subject with the illuminated light. Additionally, the chassis 107 includes: an image processor 108; a light source device 109; and a setting unit 110. The image processor 108 performs a predetermined process on a signal output from the image pickup device 101, and generates an image. The light source device 109 includes a light source that generates a light to irradiate the subject. The setting unit 110 sets image pickup (monitoring) modes of the endoscopic device. As the image pickup device 101, for example, the image pickup device of the third embodiment is used.

As explained above, according to the fifth embodiment, it is possible to reduce the diameter of the scope of the endoscopic device. As used herein, the following directional terms “forward,” “rearward,” “above,” “downward,” “vertical,” “horizontal,” “below,” and “transverse,” as well as any other similar directional terms refer to those directions of an apparatus equipped with the present invention. Accordingly, these terms, as utilized to describe the present invention should be interpreted relative to an apparatus equipped with the present invention.

The term “configured” is used to describe a component, section or part of a device includes hardware and/or software that is constructed and/or programmed to carry out the desired function.

The terms of degree such as “substantially,” “about,” and “approximately” as used herein mean a reasonable amount of deviation of the modified term such that the end result is not significantly changed. For example, these terms can be construed as including a deviation of at least ±5 percent of the modified term if this deviation would not negate the meaning of the word it modifies.

It is apparent that the present invention is not limited to the above embodiments, and may be modified and changed without departing from the scope and spirit of the invention.

What is claimed is:

1. An image pickup device comprising:
an image pickup unit including a plurality of pixels arranged in a matrix, each of the pixels being configured to generate, store, and output a pixel signal;
a first selector configured to select a column of the matrix and control the pixels arranged in the column selected; and
an output unit configured to convert into a voltage signal, the pixel signal output from each of the pixels,
wherein the image pickup unit is positioned between the first selector and the output unit.

2. The image pickup device according to claim 1, wherein the first selector is distanced from the output unit by an integral multiple of a pitch of the pixels.

3. The image pickup device according to claim 1, further comprising:
a second selector configured to select a row of the matrix and control the pixels arranged in the row selected.

4. The image pickup device according to claim 3, further comprising:
a first switch unit including a plurality of first switches provided for respective columns of the matrix;
wherein the first selector is configured to control the first switches, thereby selecting a column of the pixels to be supplied with a power voltage;
the second selector is configured to select from the pixels in the column selected, a row of the pixels to be controlled to output the pixel signals generated to the output unit; and
the first switches are positioned between the first selector and the image pickup unit.

5. The image pickup device according to claim 3, further comprising:
a second switch unit including a plurality of second switches provided for respective columns of the matrix, the second switches being electrically coupled to the first switches, respectively,
wherein the first selector is configured to control the first switches, thereby selecting a column of the pixels to be supplied with a power voltage;
the second selector is configured to select from the pixels in the column selected, a row of the pixels to be controlled to output the pixel signals generated to the output unit;
the second switch corresponding to the column selected by the first selector is configured to switch, based on control of the first selector, whether to output to the output unit, the pixel signal output from the pixel specified by the column selected by the first selector and the row selected by the second selector, and
the second switch is positioned between the image pickup unit and the output unit.

6. The image pickup device according to claim 4, further comprising:
a plurality of power lines provided for respective columns of the matrix, each of the power lines coupling the first switch and the pixels in a column, and each of the power lines being used for supplying the power voltage to the pixels in the column;
a plurality of vertical signal lines provided for respective columns of the matrix, each of the vertical signal lines coupling the pixels in a column, and each of the vertical signal lines being used for outputting the pixel signals from the pixels in the column; and
a horizontal signal line coupling the vertical signal lines and the output unit, the horizontal signal line being used for outputting the pixel signals from the vertical signal lines to the output unit.

7. The image pickup device according to claim 5, further comprising:
a plurality of power lines provided for respective columns of the matrix, each of the power lines coupling the first switch and the pixels in a column, and each of the power lines being used for supplying the power voltage to the pixels in the column;
a plurality of vertical signal lines provided for respective columns of the matrix, each of the vertical signal lines coupling the pixels and the second switch in a column, and each of the vertical signal lines being used for outputting the pixel signals from the pixels in the column; and
a horizontal signal line coupling the vertical signal lines and the output unit, the horizontal signal line being used for outputting the pixel signals from the vertical signal lines to the output unit.

8. The image pickup device according to claim 3, wherein each of the pixels comprises:
a generator configured to generate a pixel signal in accordance with an amount of an incident electromagnetic wave;
a storing unit configured to store the pixel signal generated; and
an amplifier configured to amplify the pixel signal stored.

9. The image pickup device according to claim 8, further comprising:
a transfer unit configured to transfer the pixel signal generated from the generator to the storing unit; and
a third selector configured to switch whether or not to output the pixel signal amplified to the output unit.

10. An image pickup device comprising:
a first pixel configured to generate, store, and output a first pixel signal;
a first switch configured to switch whether or not to supply a power voltage to the first pixel; and
an output unit configured to convert into a first voltage signal, the first pixel signal output from the first pixel, and output the first voltage signal
wherein the first pixel is positioned between the first switch and the output unit.

11. The image pickup device according to claim 10, further comprising:
a first selector configured to control the first switch,
wherein the first switch is positioned between the first pixel and the first selector.

12. The image pickup device according to claim 11, further comprising:
a second pixel adjacent to a first side of the first pixel, the second pixel being configured to generate, store, and output a second pixel signal,
wherein the first switch is configured to switch whether or not to supply the power voltage to the first and second pixels.

13. The image pickup device according to claim 12, further comprising:
a second selector configured to control the first and second pixels,
wherein the first selector is configured to control the first switch, thereby supplying the power voltage to the first and second pixels,
the second selector is configured to control the first and second pixels to respectively output the first and second pixel signals to the output unit.

14. The image pickup device according to claim 11, further comprising:
a third pixel adjacent to a second side of the first pixel, the second side being not opposed to the first side, the third pixel being configured to generate, store, and output a third pixel signal,
wherein the first switch is configured to switch whether or not to supply the power voltage to the first and third pixels.

15. The image pickup device according to claim 14, further comprising:
a second selector configured to control the first and third pixels to sequentially output the first and third pixel signals to the output unit.

16. The image pickup device according to claim 13, further comprising:
a second switch between the output unit and a set of the first and second pixels, the second switch being electrically coupled to the first switch, and the second switch being configured to switch, based on control of the first switch performed by the first selector, whether or not to output the first and second pixel signals to the output unit.

17. The image pickup device according to claim 12, further comprising:
a power line coupling the first switch, the first pixel, and the second pixel, the power line being used for supplying the power voltage to the first and second pixels;
a vertical signal line coupling the first and second pixels, the vertical signal line being used for outputting the first and second pixel signals; and
a horizontal signal line coupling the vertical signal line and the output unit, the horizontal signal line being used for outputting the first and second pixel signals from the vertical signal line to the output unit.

18. The image pickup device according to claim 14, further comprising:
a power line coupling the first switch and the third pixel, the power line being used for supplying the power voltage to the first and third pixels;
a vertical signal line coupled to the third pixel, the vertical signal line being used for outputting the first and third pixel signals; and
a horizontal signal line coupling the vertical signal line and the output unit, the horizontal signal line being used for outputting the first and third pixel signals from the vertical signal line to the output unit.

19. The image pickup device according to claim 16, further comprising:
a power line coupling the first switch, the first pixel, and the second pixel, the power line being used for supplying the power voltage to the first and second pixels;
a vertical signal line coupling the first pixel, the second pixel, and the second switch, the vertical signal line being used for outputting the first and second pixel signals; and
a horizontal signal line coupling the vertical signal line and the output unit, the horizontal signal line being used for outputting the first and second pixel signals from the vertical signal line to the output unit.

20. An endoscopic device comprising:
an image pickup device; and
an image processor configured to perform a predetermined process on a signal output from the image pickup device to generate an image,
wherein the image pickup device comprises:
an image pickup unit including a plurality of pixels arranged in a matrix, each of the pixels being configured to generate, store, and output a pixel signal;
a first selector configured to select a column of the matrix and control the pixels arranged in the column selected; and
an output unit configured to convert into a voltage signal, the pixel signal output from each of the pixels,
wherein the image pickup unit is positioned between the first selector and the output unit.
